(19) United States
(12) Patent Application Publication
(10) Pub. No.: US 2006/0056909 A1
(43) Pub. Date: Mar. 16, 2006

(54) Modified assembly of the joint and the fulcrum pin

(76) Inventor: Qingxin Chen, Quanzhou City (CN)

Correspondence Address: COZEN O'CONNOR, P.C., 1900 MARKET STREET, PHILADELPHIA, PA, 19103-3508, US

(21) Appl. No.: 11/169,135

(22) Filed: Jun. 28, 2005

(30) Foreign Application Priority Data
Jun. 28, 2004 (CN) 200410050141.0

(51) Int. Cl. F16C 11/00

(52) U.S. Cl. 403/135

(57) ABSTRACT

The present invention provides a modified assembly of the joint and the fulcrum pin comprising: a fulcrum pin (1), a joint casing shroud (2), two or more springs (3), a dustproof soft flapper (4) and a spring baffle (5). Several springs (3) are mounted between the fulcrum pin (1) and the joint casing shroud (2). The springs (3) are of the flexible distance to a certain degree, and the flexible direction is perpendicular to the axial direction of the fulcrum pin (1). The spring baffle is mounted on the end face of the fulcrum pin in order to keep the spring (3) from sliding. The invention is of higher rate of finished products, lower energy consumption, easier technique, better performance and longer life than the existing rubber assembly of the joint and the fulcrum pin.

### CROSS REFERENCE TO RELATED APPLICATIONS

The present application claims priority of Chinese patent application Nos. 200410050141.0 and 200420072646.2, each filed on Jun. 28, 2004, the contents of which are expressly incorporated herein by reference in their entirety.

### FIELD OF INVENTION

The present invention relates generally to a vehicle balancing unit, and specifically to a modified assembly of the joint and the fulcrum pin.

### BACKGROUND OF THE INVENTION

In the existing technology, rubber is added between the fulcrum pin and the joint casing shroud in the assembly of the joint and the fulcrum pin to prevent vibration and maintain balance with the flexible performance of the rubber. The steps are as below: (1) chemical material is added in the heat softened rubber, (2) the rubber is added to the cavity between the fulcrum pin and the joint casing shroud and then allows to cool down. Thus the fulcrum pin and the joint casing shroud are joined together by the combination of the rubber.

U.S. Pat. No. 5,865,009 disclosed a rubber expansion joint for preventing distortions, cracks, and breaks in building materials normally caused by thermal movement. The invention includes a method of making an expansion joint member from used tires and using the resulting expansion joint member by installing it into a structure to create an expansion joint.

U.S. Pat. No. 6,341,915 disclosed a rubber-cushioned ball joint with a bearing geometry which is optimized with regard to tension, The bearing geometry of a ball-and-socket joint mounted in a rubber-metal bearing is changed such that a sufficiently great pivot angle is guaranteed for the pivot pin and the surface of the elastomer is enlarged at the same time to prolong its life. The bearing is extended beyond the radius of the joint ball on its side located opposite the pivot pin projecting from the bearing. The fulcrum point of the bearing and the fulcrum point of the pivot pin mounted in the inner part are offset in relation to one another in the axial direction, wherein the inner and outer parts of the bearing are conically expanded. The rubber-mounted ball-and-socket joint may have, on at least one side, at least one insert with a Shore hardness lower than that of the elastomer. The insert may be inserted into the elastomer.

In the existing technology, several problems appear: (1) The degree of bonding may be unsatisfactory because of the rubber physicochemical properties of the rubber and defects in its manufacturing process. Once the external force goes beyond the limit, the fulcrum pin and the joint casing shroud will disconnect and therefore endanger the vehicle; (2) the rubber is of low resistance to stretching and compressing, which results in breaking down in long-term use; and (3) the manufacture is complicated and very costly; more raw materials, machining equipments and energy are required.

### SUMMARY OF THE INVENTION

The invention solves the above-mentioned problems, and provides a modified assembly of the joint and the fulcrum pin.

In the present invention, two or more resilient members are added between the fulcrum pin and the joint casing shroud in the assembly of the joint and the fulcrum pin to prevent vibration and keep balance with the flexible performance of the resilient members, thereby reducing and, in some embodiments, eliminating potential damage or destruction to the assembly.

The resilient members connect the fulcrum pin with the joint casing shroud and the baffle, mounted by weld or combination and fastening which can, in some embodiments, prevent the resilient members from sliding. The dustproof soft flapper is mounted in the baffle in order to keep foreign objects including dust, sand or any other undesirable material out.

Advantages of the present invention include, but are not limited to: (1) longer life, (2) better buckling stress, (3) better shearing stress and (4) better pressure.

The present invention is directed to these, as well as other, important needs.

### BRIEF DESCRIPTION OF THE DRAWINGS

FIG. 1 is an overhead view of a modified assembly of the joint and the fulcrum pin.

FIG. 2 is a schematic drawing of the assembly with a spring baffle.

FIG. 3 is a schematic drawing of a spring baffle.

FIG. 4 is a schematic drawing of the dustproof soft flapper.

In the figures, the reference numbers refer to:
1—the fulcrum pin
2—the joint casing shroud
3—the spring
4—the dustproof soft flapper
5—the spring baffle.

### DETAILED DESCRIPTION OF THE DRAWINGS

Referring now to the drawings, a preferred modified assembly consisting of the modified joint and the fulcrum pin according to the present invention is described in more detail in order to describe the features and spirit of the present invention.

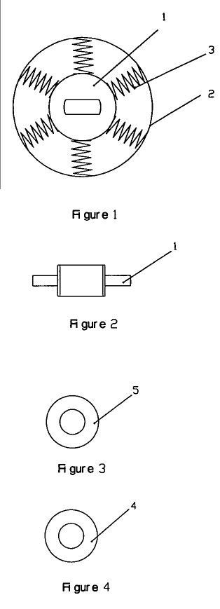

FIG. 1 is an overhead view of a modified assembly consisting of the spring joint and the fulcrum pin. The spring 3 is arrayed equably between the fulcrum pin 1 and the joint casing shroud 2, and it is of a certain flexible distance. The flexible direction of the spring 3 is perpendicular to the axis direction of the fulcrum pin 1. Thus, as shown in FIG. 1, several springs 3 are arrayed evenly around the fulcrum pin 1 and present emissive shape. In some embodiments, springs are arrayed around the fulcrum pin unevenly. One end of the springs contacts the outer portion of the fulcrum pin 1, with the other end contacting the inner face of the joint casing shroud 2. In the present invention, the number of springs 3 can be selected according to the joint's size. For example, in some embodiments, 3, 4, 5, 6, 7, 8, 9 or 10 springs connect the fulcrum pin to the joint casing shroud.

As used herein the term resilient member includes, without limitations, springs, including leaf and coil springs, compressible materials, including compressible rubber materials, and shock absorbing apparatus or materials.

Referring to FIG. 2, the spring baffle 5 is mounted at both sides of the flange ends of the fulcrum pin 1 in order to keep the spring 3 from sliding. As used herein, the term baffle includes baffles for the resilient members and includes spring baffles.

Referring to FIG. 3, the spring baffle 5 may be made of steel sheet, and connected to the joint by means of welding or buckling. This can keep the spring 3 from sliding and protect against foreign objects including, for example, dust. Those skilled in the art would be able to select other appropriate materials for the construction of the spring baffle.

Referring to FIG. 4, the dustproof soft flapper 4 may be made of rubber, plastic or other similar materials; it is mounted between the two sides flange ends of the fulcrum pin 1 and the spring baffle 5, and then clamped. Those skilled in the art would be able to select other appropriate materials for the construction of the dustproof soft flapper.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the present invention. All patent applications and references cited herein are incorporated herein in their entireties by reference.

What is claimed is:

1. A joint and fulcrum pin assembly comprising:
a fulcrum pin;
a joint casing shroud; and
two or more resilient members mounted between the fulcrum pin and the joint casing shroud,
wherein the expanding direction of the resilient members is perpendicular to the axial direction of the fulcrum pin.

2. The joint and fulcrum pin assembly of claim 1 wherein the resilient member is one or more of a leaf spring, a coil spring, a compressible material, or shock absorbing material or apparatus.

3. The joint and fulcrum pin assembly of claim 1 wherein the resilient member is a spring.

4. The joint and fulcrum pin assembly of claim 1 further comprising a baffle fastened to the end face of the fulcrum pin.

5. The joint and fulcrum pin assembly of claim 4 wherein the resilient member is a spring and the baffle is a spring baffle.

6. The joint and fulcrum pin assembly of claim 1 further comprising a dustproof baffle.

7. The joint and fulcrum pin assembly of claim 6 wherein the dustproof baffle is made of plastic.

8. The joint and fulcrum pin assembly of claim 4 wherein the baffle is made of one or more rigid materials.

9. The joint and fulcrum pin assembly of claim 4 wherein the baffle is permanently fixed to the flange end face of the fulcrum pin.

10. The joint and fulcrum pin assembly of claim 4 wherein the baffle is welded to the flange end faces of the fulcrum pin.
